(19) United States
(12) Patent Application Publication
(10) Pub. No.: US 2009/0295128 A1
(43) Pub. Date: Dec. 3, 2009

(54) STROLLER, CHILD SAFETY SEAT AND CHILD SAFETY SYSTEM

(76) Inventors: Keith C. Nagelski, Huntersville, NC (US); Jon T. McGuire, Tega Cay, SC (US); Tom Philpott, Charlotte, NC (US); Ian Kovacevich, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/397,864

(22) Filed: Mar. 4, 2009

Related U.S. Application Data
(60) Provisional application No. 61/033,530, filed on Mar. 4, 2008.

(51) Int. Cl. B62B 7/14

(52) U.S. Cl. 280/642

(57) ABSTRACT

A stroller including a stroller frame have pivotally connected first, second and third frame elements configured to fold between deployed and collapsed configurations, seat back and bottom portions, a single hand operated frame release mechanism for releasing engagement between the first and second frame elements to collapse the stroller, and a pivoting child tray assembly for releasably locking engagement of the first and second frame elements together.

### TECHNICAL FIELD AND BACKGROUND OF INVENTION

1. Field of the Invention

The present invention relates generally to the field of child seating systems, and more particularly, to a seating system including a stroller configured to be collapsed with one hand, a corresponding infant carrier including an adjustable headrest, and a vehicle seat base to which the infant carrier detachably engages. Elements of the seating system may used together or separately and are of the type principally intended to provide safe seating conditions for infants and small children during stroller perambulation and while riding in vehicles.

2. Background of the Invention

Seating system products for infants and children are regulated by governmental authorities in order to provide a safe environment during vehicle operation. Many such seats also provide features that permit the seat to be easily removed from and installed in the vehicle, and provide the ability for the seat to be carried or attached to other conveyances, such a stroller as discussed in this application. As governmental regulations have changed, seats have been designed to provide, for example, secure latching points to the vehicle seat, rear-facing attachment to the vehicle seat, separation and removal of a carrier portion from a base portion, and adjustment of the carrier to accommodate the size of the child's growth during the period of seat use that comply with these regulations. Conventional seating systems have incorporated some such features piecemeal, and thus present countervailing disadvantages, such as unnecessary weight and bulk, difficulty in removing the carrier/base combination from a vehicle, attaching the carrier/base combination to the vehicle seat, or the carrier from the base, and adjusting the carrier and/or base to accommodate the child's growth.

The present application discloses a child safety system that has been designed to be relatively light weight, compact, easy to use, versatile and adaptable to a wide range of vehicle seating types and features, while achieving a high standard of comfort and safety. Within the basic design, provision has been made for the addition or removal of features to achieve compliance with varying governmental regulations. In particular, the seat can be used with fixed Isofix latches, tethered Isofix latches or vehicle seatbelt locks.

The stroller, infant carrier and their components are expressly intended to be functional either separately or in combination as a system, with or without the seat base, which, may in many instances, remain fixed in place on a vehicle seat. The system also includes several novel features that separately and collectively provide both the operator and seat occupant with a more convenient, comfortable, and safe experience.

### SUMMARY OF THE INVENTION

In one aspect, a child seating system is provided including a stroller, an infant carrier, and a carrier seat base.

In another aspect, a child seating system is provided that is lightweight and compact, has a wide range of adjustment and adaptability, and permits certain elements to be manipulated with a single, free hand.

In yet another aspect, a child seating system is provided that is easily installed in and removed from a vehicle seat.

In yet another aspect, a child seating system is provided including an infant carrier configured to be readily, releasably detached from a vehicle seat base.

In yet another aspect, an infant carrier is provided configured to be carried by other conveyances, such as a stroller also disclosed herein.

In yet another aspect, an infant carrier is provided including an adjustable, winged headrest and a incrementally rotatable carry handle.

In yet another aspect, a vehicle seat base is provided including an anti-rebound bar and seat belt retention mechanism.

In yet another aspect, a stroller is provided including a single handed release mechanism for collapsing the stroller.

In yet another aspect, a stroller is provided including an adjustable seat occupant tray table.

In yet another aspect, stroller accessories are provided herein.

To achieve the foregoing and other aspects and advantages, a stroller is provided including a stroller frame including first, second and third frame elements that are pivotally interconnected such that the stroller is configured to fold between deployed and collapsed configurations, seat back and seat bottom portions suspended between the stroller frame, a frame release mechanism including a frame release element mechanically coupled to frame element releasing plungers that maintain the first and second frame elements in engagement, and a pivoting child tray assembly that releasably engages the plungers to prevent the plungers from translating downward with respect to the first frame element when the child tray assembly is engaged with the plungers. Actuating the frame release mechanism when the pivoting child tray assembly is disengaged from the plungers releases locked engagement between the first and second frame elements.

The pivoting child tray assembly includes a child tray portion releasably attached to tray support arms, and a pull mechanism for releasing engagement of the child tray assembly with the plungers. The child tray assembly further includes first and second tray support arms, and wherein detachment of the child tray portion from the first arm allows the tray table portion to pivot relative to the second support arm. The tray table assembly further includes latch hooks that engage catches defined in the plungers. To fold the stroller, the child tray assembly is released from engagement with the plungers and pivoted upwardly with respect to the first frame element, the stroller is then folded trapping the third frame element between the first and second frame elements.

In another embodiment, a stroller is provided including a stroller frame have pivotally connected first, second and third frame elements configured to fold between deployed and collapsed configurations, seat back and bottom portions, a single hand operated frame release mechanism for releasing engagement between the first and second frame elements to collapse the stroller, and a pivoting child tray assembly for releasably locking engagement of the first and second frame elements together.

In yet another embodiment, a child seating system is provided including an infant carrier comprising a molded shell defining seat back and seat bottom portions, a carry handle pivotally attached to the shell, and a height adjustable winged headrest, a vehicle seat base for receiving the infant carrier and securing the infant carrier to a vehicle seat, and a stroller for receiving the infant carrier, the stroller including the configuration described above.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of a stroller and corresponding infant carrier shown disengaged in accordance with an embodiment of the invention;

FIG. 2 is a perspective view of the infant carrier of FIG. 1 and corresponding seat base shown disengaged in accordance with an embodiment of the invention;

FIG. 3 is a perspective view of the infant carrier of FIG. 1 shown with the upholstery removed to illustrate a height adjustable headrest;

FIG. 4 is a side elevation view of the carrier of FIG. 1 including a level;

FIG. 5 is a rear elevation view of the infant carrier of FIG. 1;

FIG. 6 is a detailed perspective view of the carry handle attachment portion of the infant carrier of FIG. 1;

FIG. 7 is a plan view of the bottom of the infant carrier of FIG. 1;

FIG. 8 is a plan view of the bottom of the infant carrier of FIG. 1 including shoulder straps shown in a lower headrest position;

FIG. 9 is a plan view of the bottom of the infant carrier of FIG. 1 including shoulder straps shown in the upper headrest position;

FIG. 10 is a perspective view of the infant carrier of FIG. 1 with the carry handle shown rotated to a position to support the infant carrier;

FIG. 11 is a perspective view of the seat base of FIG. 2 including an anti-rebound bar and seat belt retention mechanism;

FIG. 12 is an exploded perspective view of the seat base of FIG. 11 illustrating seat belt routing and belt tensioner;

FIG. 13 is a plan view of the bottom of the seat base of FIG. 2 illustrating the belt tensioner;

FIG. 14 is a front elevation view of the stroller of FIG. 1;

FIG. 15 is a front perspective view of the stroller of FIG. 1 illustrating the tray table operation;

FIG. 16 is a perspective view of the stroller of FIG. 1 shown with the tray table in the raised configuration and a user actuating the stroller-collapsing strap;

FIGS. 17-19 are detailed perspective views of the routing of the stroller-collapsing mechanism;

FIG. 20 is a detailed perspective view of the collapse of the frame of the stroller of FIG. 1;

FIG. 21 is a perspective view of the stroller of FIG. 1 shown in the collapsed configuration;

FIGS. 22-25 are detailed perspective views of the tray table assembly;

FIGS. 26-28 are detailed perspective views illustrating the removal of the tray table assembly from the stroller;

FIGS. 29-30 are detailed perspective views illustrating the partial detachment and rotation of the tray table assembly;

FIG. 31 is a perspective view of the stroller of FIG. 1 including a cup holder accessory; and

FIG. 32 is a perspective view of the stroller of FIG. 1 including installed stroller canopy accessories.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

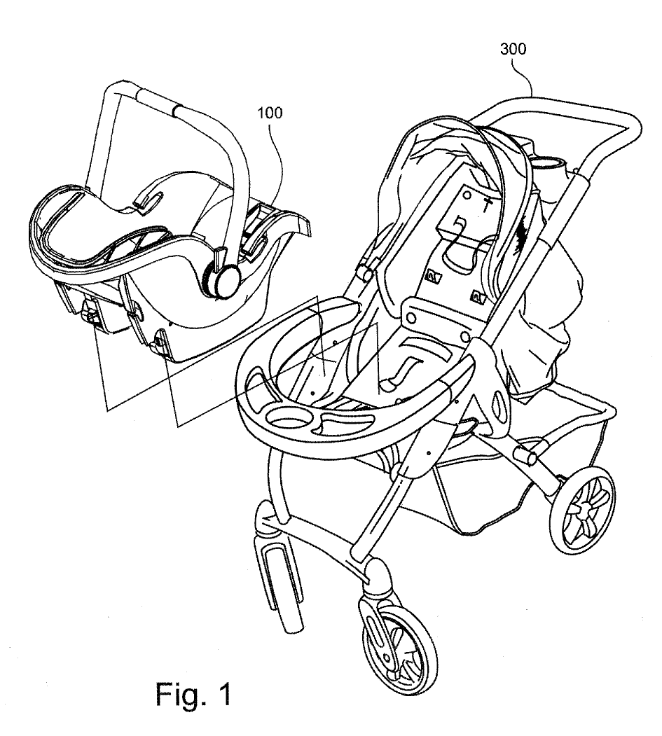

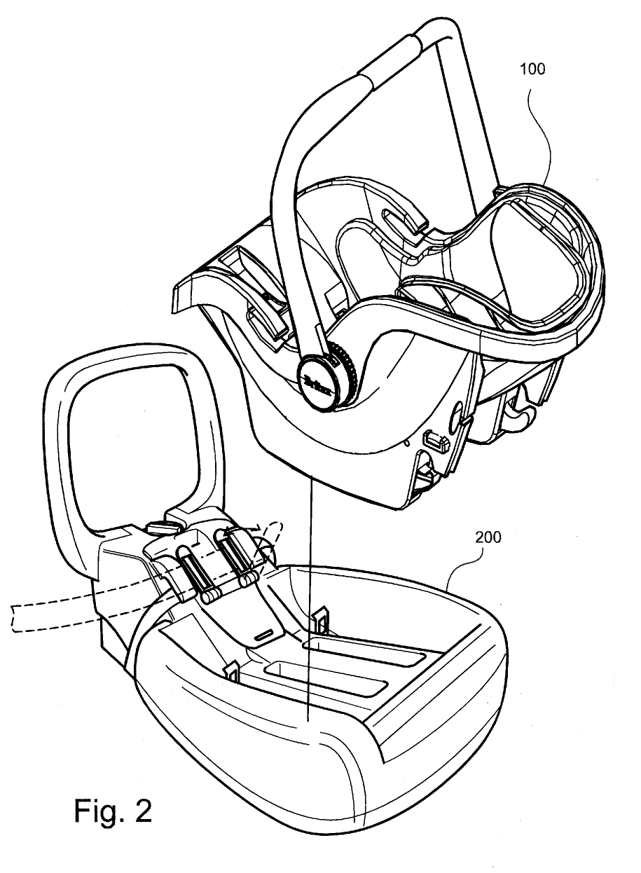

Referring now to FIGS. 1 and 2, a preferred embodiment of a compatible infant carrier 100, seat base 200 and stroller 300 are provided that collectively comprise a child seating and safety system. The infant carrier 100 of the safety system may functions as a self-supporting carrier or may be carried by the stroller 300 or other conveyance. The infant carrier 100 releaseably engages the seat base 200, which in turn is securely and releaseably attached to a vehicle seat. Thus, the seat base 200 may be left in place as desired, while the infant carrier 100 is removed and used separately, such as carried by the stroller 300. The further disclosure and explanation of the child seating system continues with a sequential explanation of the infant carrier 100, seat base 200 and stroller 300, followed by an explanation of their interrelationship with each other and other features of the child seating and safety system.

Infant Carrier

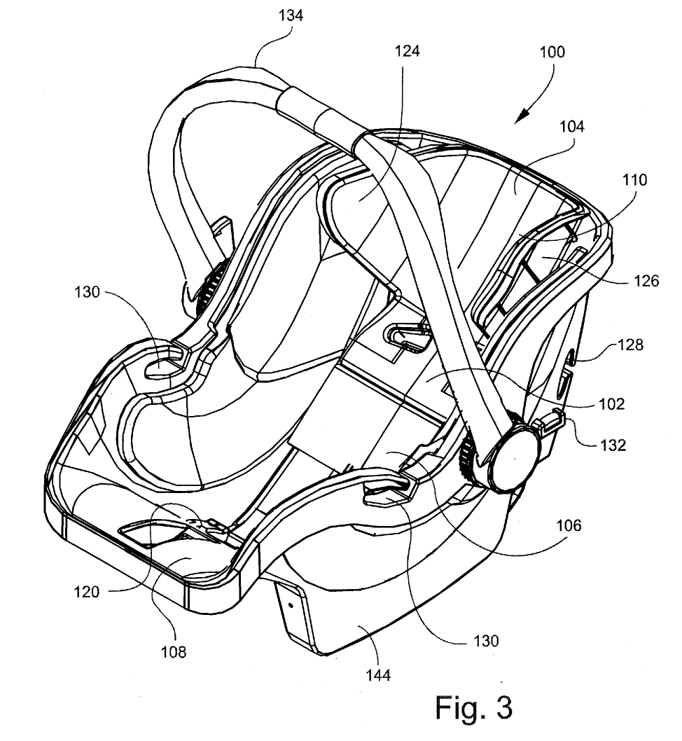

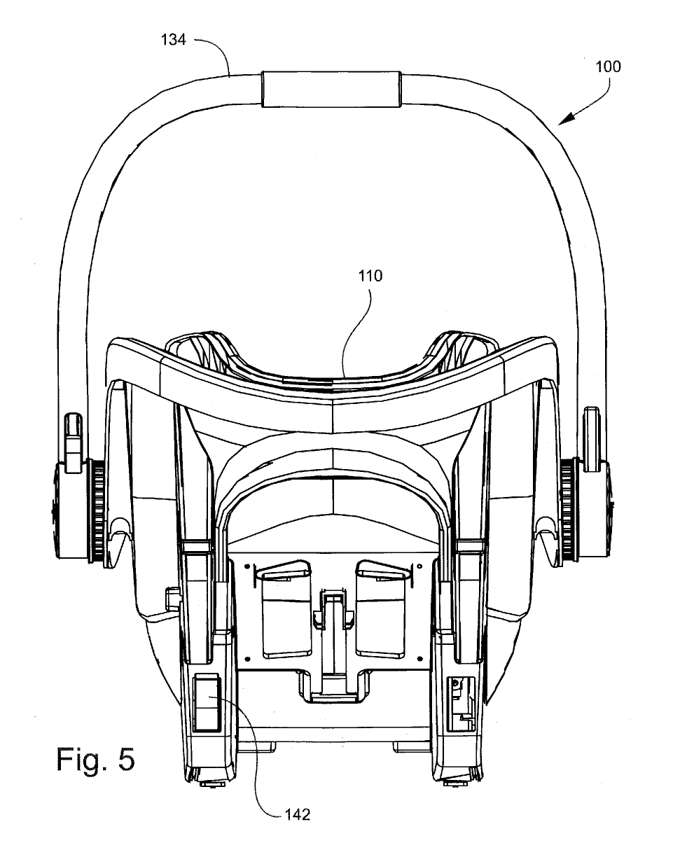

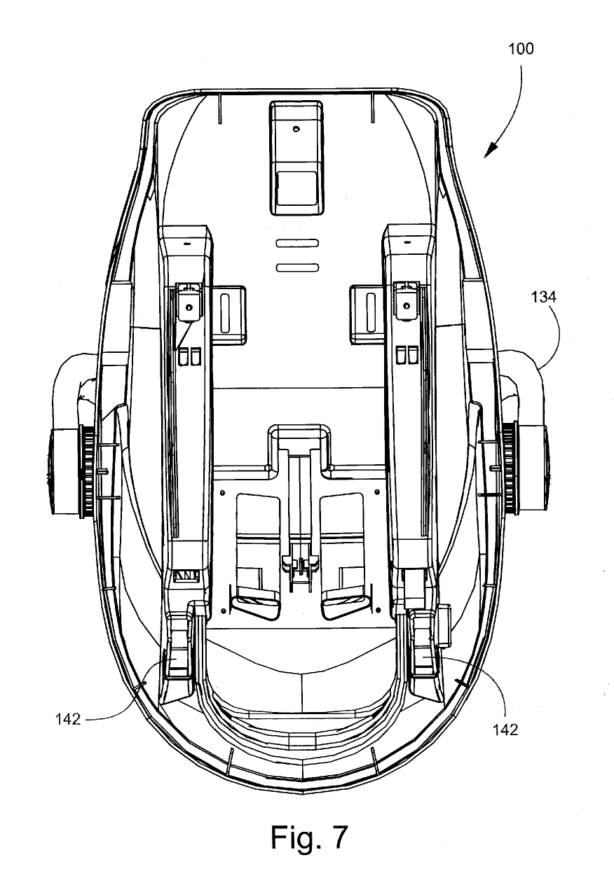

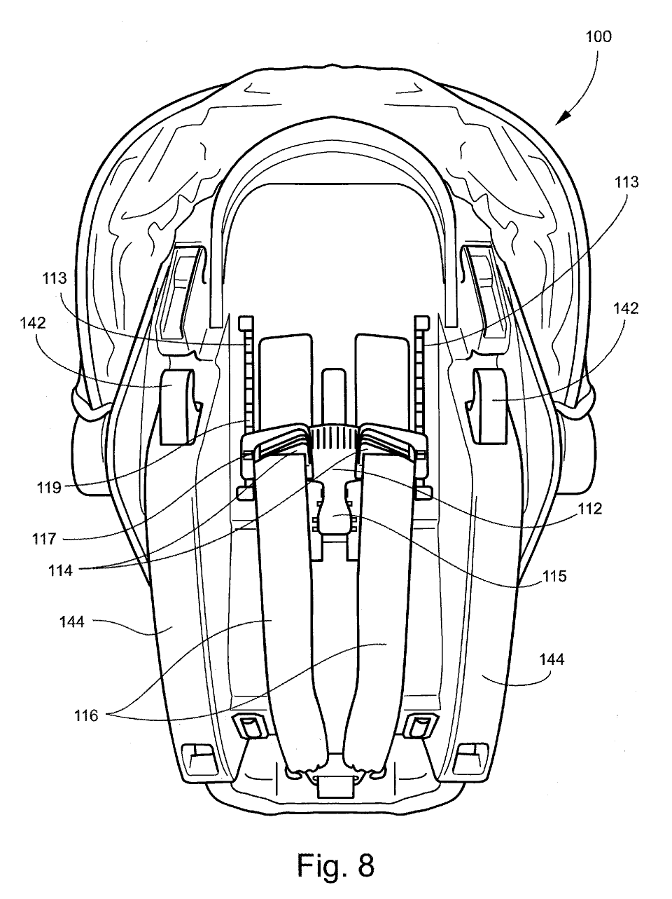

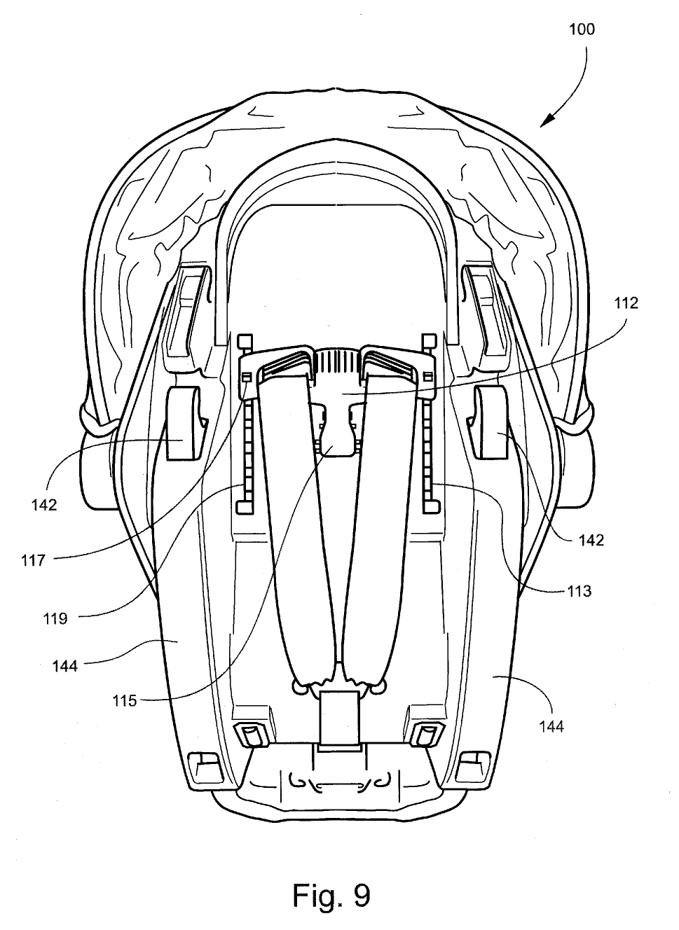

Referring to FIGS. 3-10, the infant carrier configuration is shown. In several of the figures, the carrier upholstery and padding has been removed for clarity and to illustrate underlying support structure and carrier features. The carrier is preferably molded of high-impact plastic according to conventional plastic molding techniques and includes a shell with an upper back rest portion 102, a head rest portion 104, a torso portion 106 and leg rest portion 108. A head rest insert 110 is positioned about the head rest portion 104 and is preferably molded of a semirigid, impact-absorbing material such as expanded polystyrene (EPS). The interior side-to-side distance of an exemplary embodiment of the headrest insert 110 is approximately 310 mm. The headrest insert 110 defines right and left winged portions 124 and 126, respectively, for protecting the sides of the head of the seat occupant. The headrest insert 110 is adapted for selective adjustment between a fully lowered position as shown in FIG. 8, and a fully raised position as shown in FIG. 9.

As best shown in FIGS. 8 and 9, the head rest insert 110 is adjusted by an adjustment mechanism 112 that permits a controlled, incremental sliding of a slide 115 along tracks 113 carried on the rear surface of the headrest portion of the shell. To position the adjustment mechanism 112, catches 117 of the slide 115 are elevated from the tracks 113, the mechanism is moved to a desired position along the tracks 113, and the catches 117 are lowered into engagement with detents 119 defined by the tracks 113. The adjustment mechanism 112 further defines a pair of slots 114 for capturing and routing the left and right shoulders straps 116. The position of the adjustment mechanism 112 along the tracks 113, and in turn the headrest insert 110, corresponds to the height of the seat occupant. The adjustment mechanism 112 is preferably actuated from the back of the carrier 100, thus preventing the seat occupant from accessing the mechanism 112, or the mechanism 112 being moved when the carrier 100 is engaged with the corresponding seat base 200. The back of the shell further includes a belt guide.

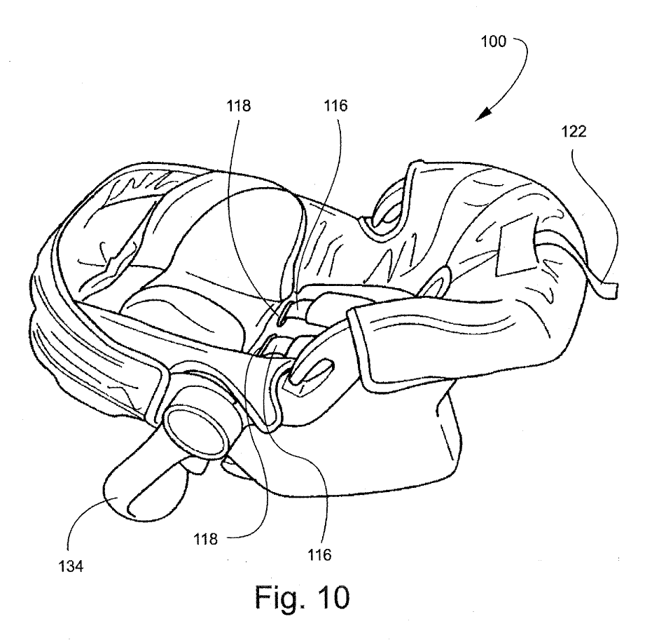

Shoulder harness slots, shown in FIG. 10, accommodate the pair of shoulder straps 116 that extend through the back of the shell and pass over the shoulders of the seat occupant. The shoulder straps 116 gain access to the exterior of the carrier 100 through slots in the padding and dress cover. The shoulder straps 116 are tightened by a latch 120, shown in FIG. 3, commonly known as an “A-lock adjustor”, positioned in an opening in the leg rest portion 108 of the shell that captures and retains a single latch strap 122 that extends past the latch 120 and is tightened by pulling the strap through the latch 120. The latch strap 122 is released by depressing the latch 120 to release an engagement with the strap to permit it to be withdrawn from the latch 120 by pulling on the shoulder straps 116.

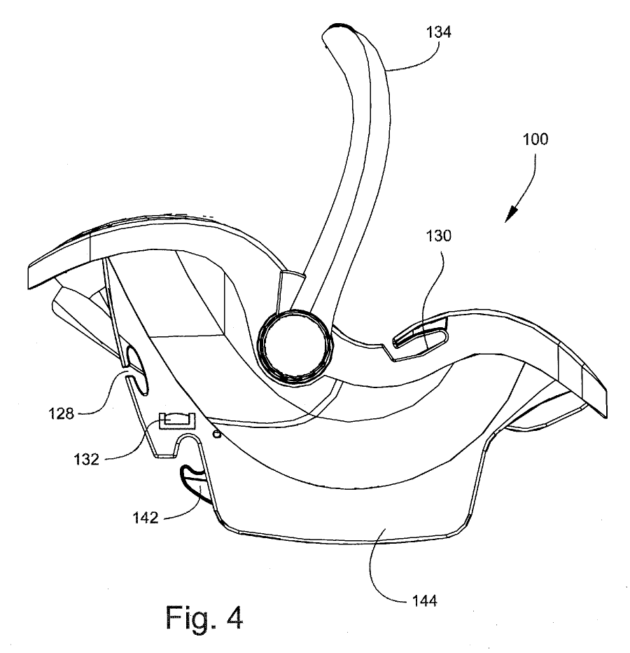

As best shown in FIGS. 3 and 4, the carrier 100 includes a pair of belt path slots 128 positioned on opposite sides of the carrier shell that permit a vehicle seat belt to be extended laterally over the carrier, correctly positioned relative to the carrier, and retained in that position. The carrier 100 further defines stroller strap slots 130 positioned on opposite sides of the carrier shell for receiving stroller straps terminating in a catch/buckle for securing the carrier 100 within the stroller. Referring to FIG. 4, the carrier 100 further includes a level 132 which provides a visual indication and confirmation that the carrier is properly leveled. The level indicator may be a “bubble” type level, a pendulum-type level, or any other suitable means of permitting adjustment of the child safety seat or infant carrier into a suitably level position on the seat base 200, and may be positioned on either one or both sides of the carrier. Alternatively, the level 132 may be carried on the seat base 200.

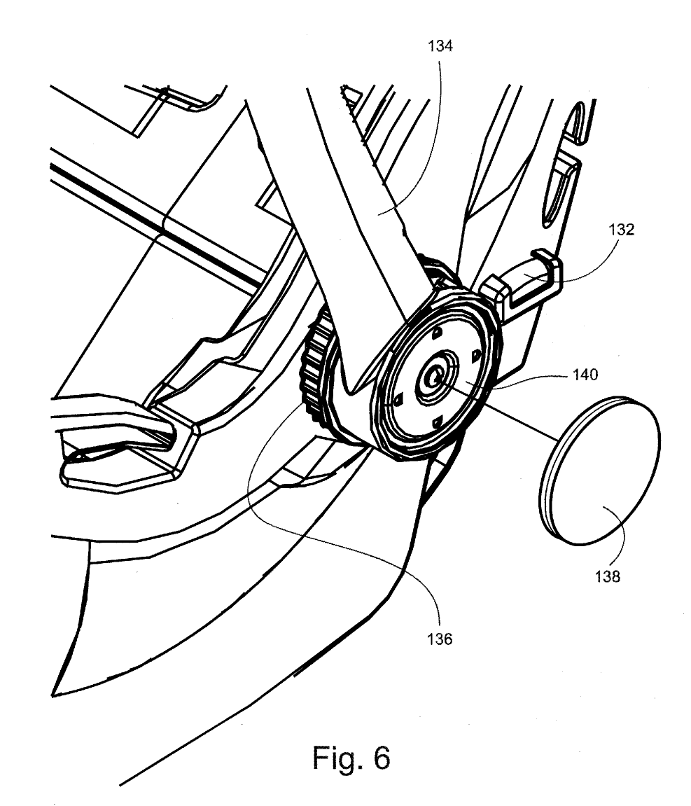

The carrier 100 is lifted and carried by means of a carry handle 134, shown in FIGS. 3-6. Referring specifically to FIG. 6, the carry handle 134 is mounted to annular hubs 136 of the carrier 100. Rotation of the handle 134 to the desired position is achieved by releasing a pair of handle position locks 138. Simultaneously depressing both of the position locks 138 radially inwardly towards the respective hubs releases engagement between the position locks 138 and respective mating locking mechanisms 140 in the hubs 136 and allows the handle to be rotated as desired. Releasing the position locks 138 fixes the handle 134 into the desired position. The locking mechanisms 140 in the hubs operate independently of the hubs themselves, which are stationary. The locking mechanism 140 allows for incremental rotation of the carry handle 134.

As shown in FIG. 3, the carry handle 134 is properly positioned to carry the infant carrier 100 and to protect the seat occupant, to a degree, from impact from the front or overhead. As shown in FIG. 10, the carry handle 134 may be rotated over and beyond the headrest portion of the carrier to a position beneath and supporting the carrier, thus aiding in supporting the carrier on a supporting surface and preventing the carrier from tipping backward. Thus, the carry handle 134 preferably defines a width and height of great enough dimension so as to clear the carrier shell when rotated. The carry handle 134 may be contoured or include a grip for gripping the handle 134.

Referring to FIGS. 4, 5, 7, 8 and 9, the carrier 100 further includes carrier latches 142 on the shell that releasably engage with corresponding features of the seat base 200. The corresponding features of the seat base 200 include slots that contain respective locking bars that capture the carrier latches 142 and lock the carrier 100 and seat base 200 together. Referring to FIGS. 3, 4, 8 and 9, the carrier 100 and seat base 200 are further stabilized and maintained in fixed position with relation to each other by means of a pair of relatively large, elongate feet 144 that fit into mating elongate recesses formed in the seat base 200. The feet 144 make up a substantial portion of the length of the bottom of the infant carrier 100, thus providing a stable carrier/seat base interface.

Seat Base

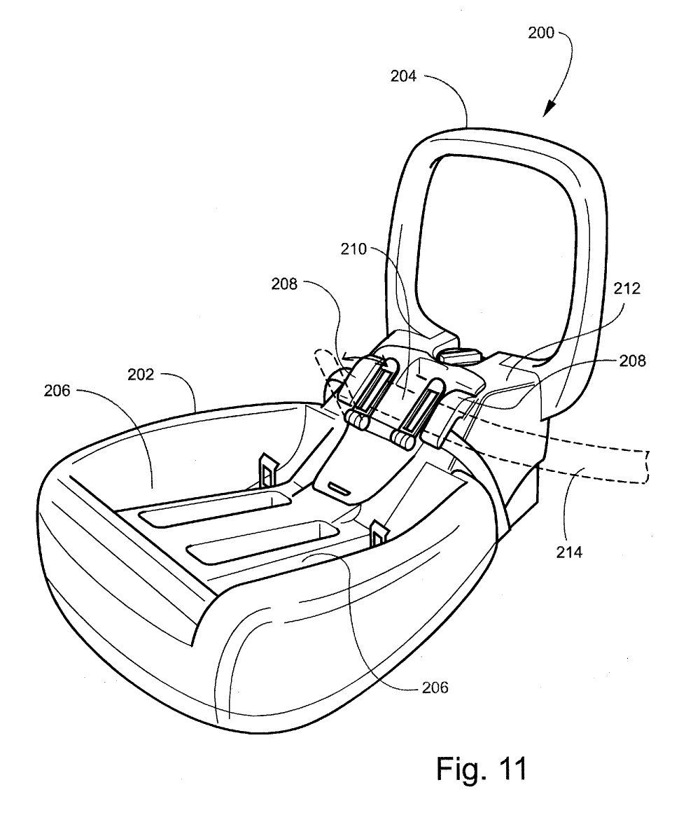

Referring to FIGS. 11-13, the seat base 200 includes an infant carrier receiving portion 202 coupled with an anti-rebound bar 204 that projects outwardly and upwardly from the foot end of the base and engages the seat back of the vehicle seat to which the seat base 200 is attached. In the event of an impact or sudden change in velocity of the vehicle in which the seat base 200 is carried, the anti-rebound bar 204 retards inertia-induced rotation of the seat base and the attached carrier by transmitting rotational force applied to the seat base into the vehicle seat back. Like the carrier 100 above, the seat base 200 is preferably molded of high-impact plastic according to conventional plastic molding techniques.

The carrier receiving portion 202 defines recesses 206 for receiving the elongaged feet of the infant carrier 100. The seat base 200 may be secured to the vehicle seat by either use of the vehicle seat belt or conventional “Isofix”-type latches. The base includes a pair of spaced-apart belt hooks 208 and a belt lock-off 210 positioned therebetween mounted on the top of a housing 212 positioned on the foot end of the base. The belt hooks 208 are slightly spaced from the curved upper surface of the housing and define space beneath sufficient to accommodate the thickness of the seat belt. The seat belt 214 is extended laterally across the housing under the belt hooks 208 with the belt lock-off 210 in an open position. The belt lock-off 210 positioned between the two belt hooks 208 is locked down over the seat belt 214, preventing it from moving in either an extension or retraction direction. The housing 212 also acts as a support for the foot end of the carrier 100.

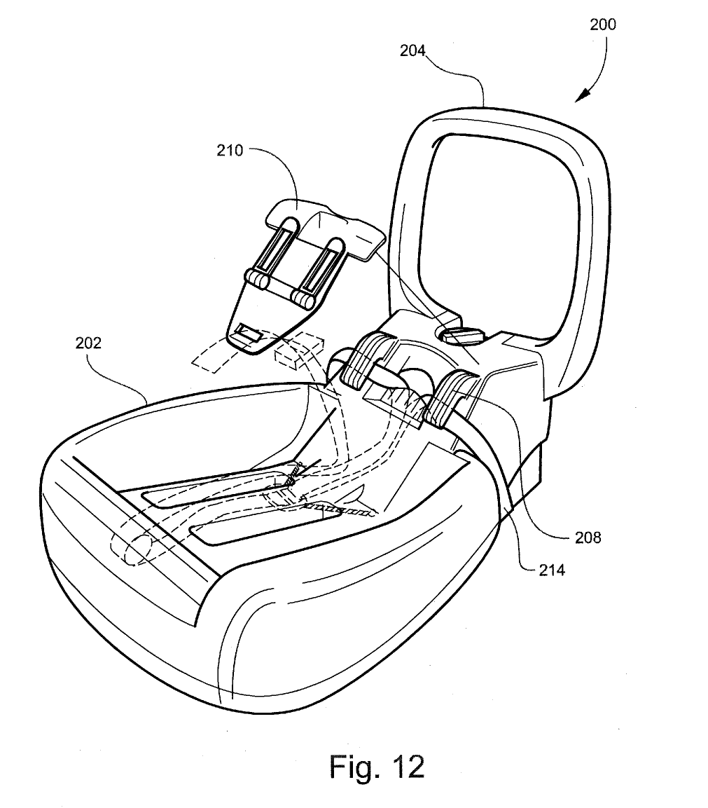

As shown in FIGS. 12 and 13, the seat base 200 optionally includes a belt tensioner 216 located on a bottom surface of the seat base 200 for applying tension to and aid in retaining the seat belt 214 to the base. The belt tensioner 216 includes a strap 218 that loops over the installed seat belt 214. The strap 218 is tightened by a latch positioned in an opening in the seat base 200 that captures and retains the strap 218 that extends past the latch and is tightened by pulling the strap through the latch. The strap 218 is released by depressing the latch to release an engagement with the strap to permit it to be withdrawn from the latch by pulling on the strap 218. Conventional Isofix latches may be affixed to tethers that are joined to the strap 218 positioned in an Isofix lock-off positioned at the mid-point of the base between the front and rear ends. The Isofix latches may thus be extended to provide sufficient slack to allow them be latched onto the Isofix bars behind the vehicle seat, and then retracted by pulling on the strap 218 in the area of the Isofix lock-off. Pulling the strap 218 draws the seat base 200 towards the vehicle seat, and, when suitably tight, the Isofix lock-off is used to lock the strap 218 into a fixed position and thus secure the seat base 200 in the desired position. Alternatively, the seat base 200 may be secured to the vehicle seat by means of Isofix latches fixed to the base and adapted to latch directly to Isofix bars positioned behind the vehicle seat bottom that are now required on many vehicles.

Stroller

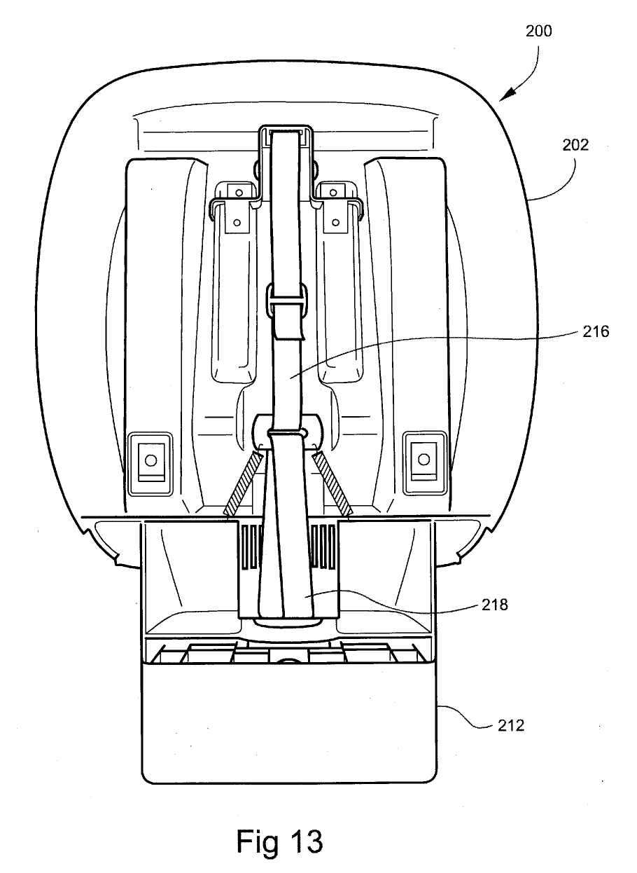

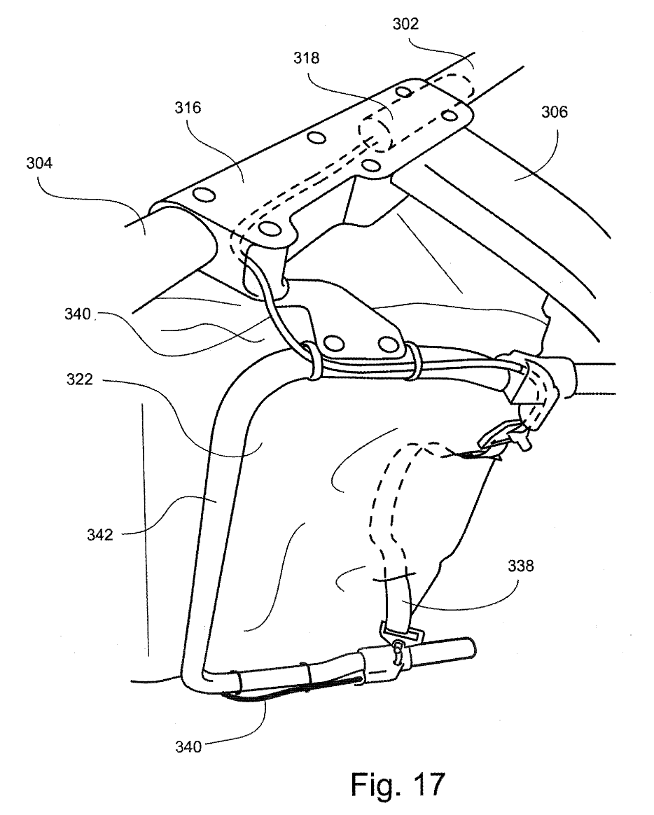

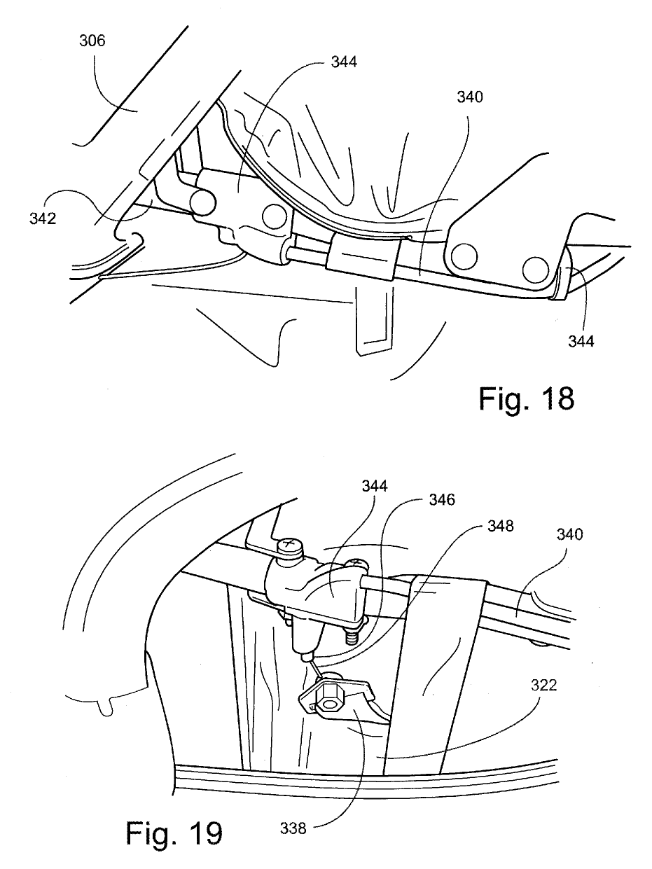

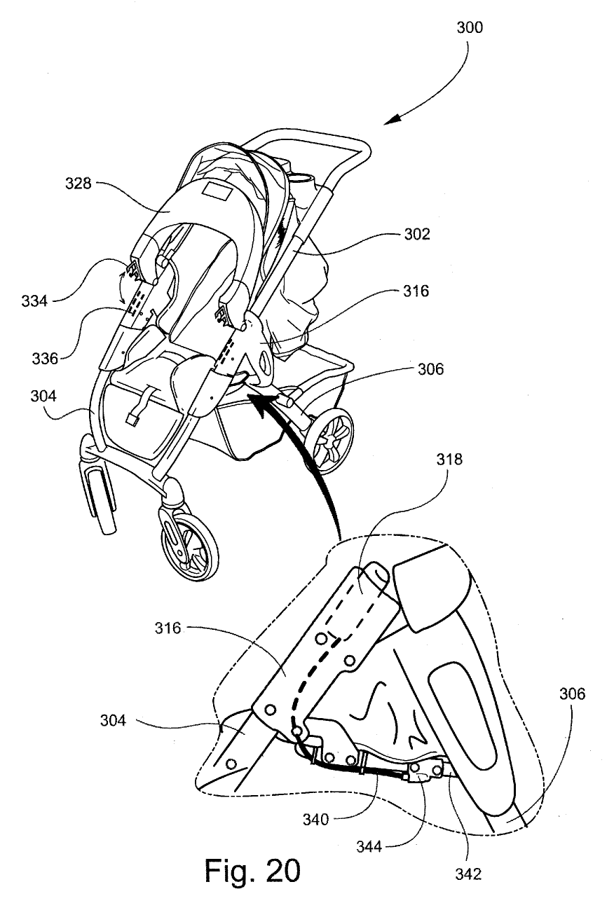

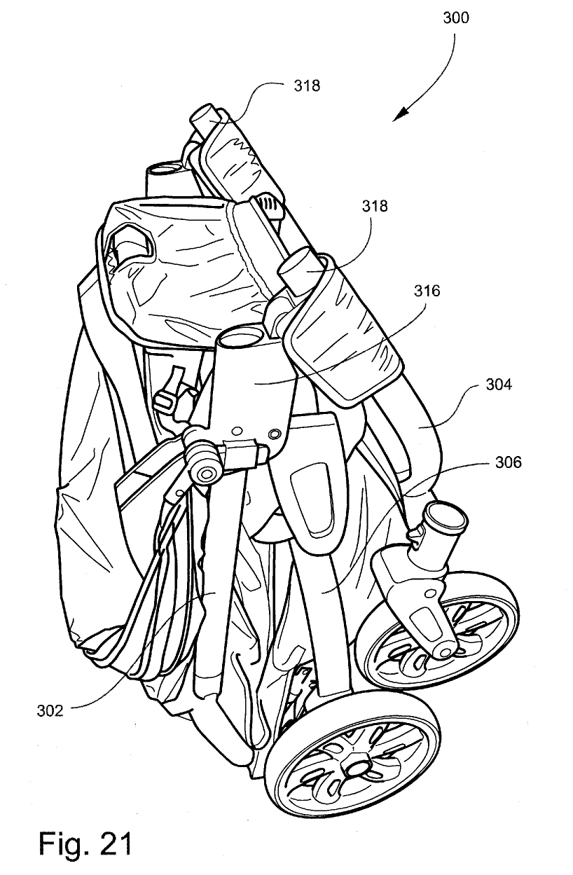

Referring to FIGS. 14-21, a stroller 300 in accordance with a preferred embodiment of the invention is shown. The stroller 300 is configured to fold between a deployed configuration as best shown in FIGS. 14-16, and a compact, folded configuration as best shown in FIG. 21. A stroller frame includes first, second and third tubular frame elements 302, 304 and 306, respectively, interconnected through hinges to provide folding. When collapsed, the handle end of first frame element 302 and the wheel carrying end of the second frame element 304 pivot toward one another, thereby trapping the third frame element 306 therebetween. The first frame element 302 defines the upper frame portion of the stroller and the stroller handle 308, which may optionally be telescoped into the open upper ends of the first frame element 302 to reduce the size of the folded configuration or provide handle height adjustability. The second frame element 304 makes up the lower front portion of the stroller 300 and includes tubular frame members joined by a bumper portion 310 to which at least one front wheel 312, a pair as shown, is rotatably and pivotally mounted. The third frame element 306 makes up the lower, rear portion of the stoller 300 and terminates at one end in a pair of rotating rear wheels 314. The first, second and third frame elements 302, 304 and 306 interconnect through at least one hinge about brackets 316. First frame element 302 releasably locks into engagement with second frame element 304 through first and second frame element releasing translating plungers 318 biased in the direction of the first frame element 302, as described in more detail below.

Seat back and seat bottom portions 320 and 322, respectively, are suspended between the frame elements 302, 304 and 306. The seat back portion 320 is configured to move between upright and reclined positions. A harness 324 including shoulder straps, such as a 5-point harness, is attached to the seat back and bottom portions 320 and 322. A canopy 326 is mounted on pivots and allows the seat occupant to be shaded or otherwise protected from the elements as desired. A child tray assembly 328 is mounted on pivots and is moveable between an in use configuration and a raised configuration for unloading the stroller 300 and additionally releasing the plungers 318 to disengage the first and second frame elements 302 and 304 to collapse the stroller. The stroller 300 further includes a luggage basket 330 supported by the third frame element 306 and an optional parent tray 332 defining cup holders and/or storage compartments carried on the first frame element 302.

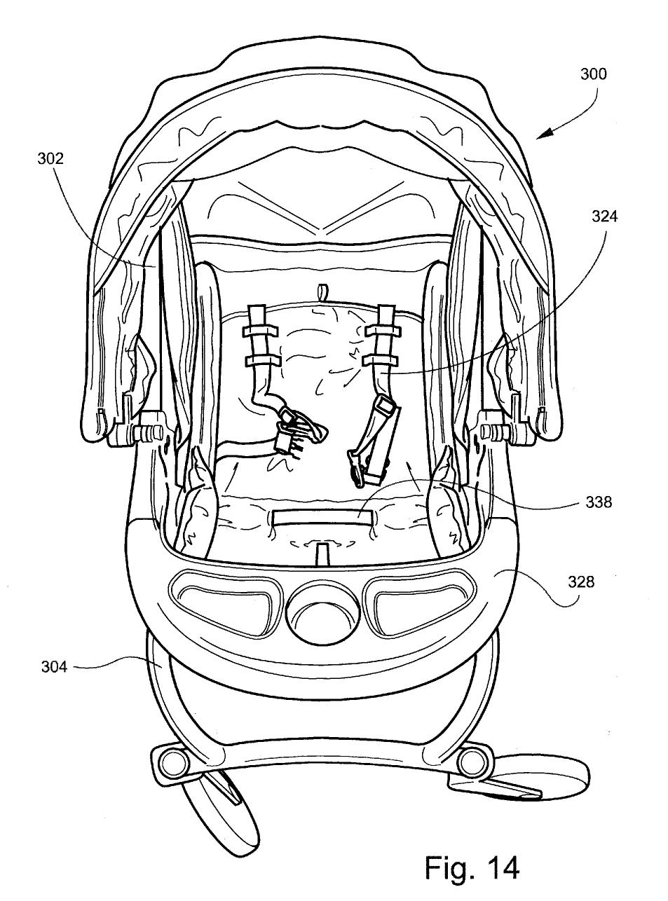

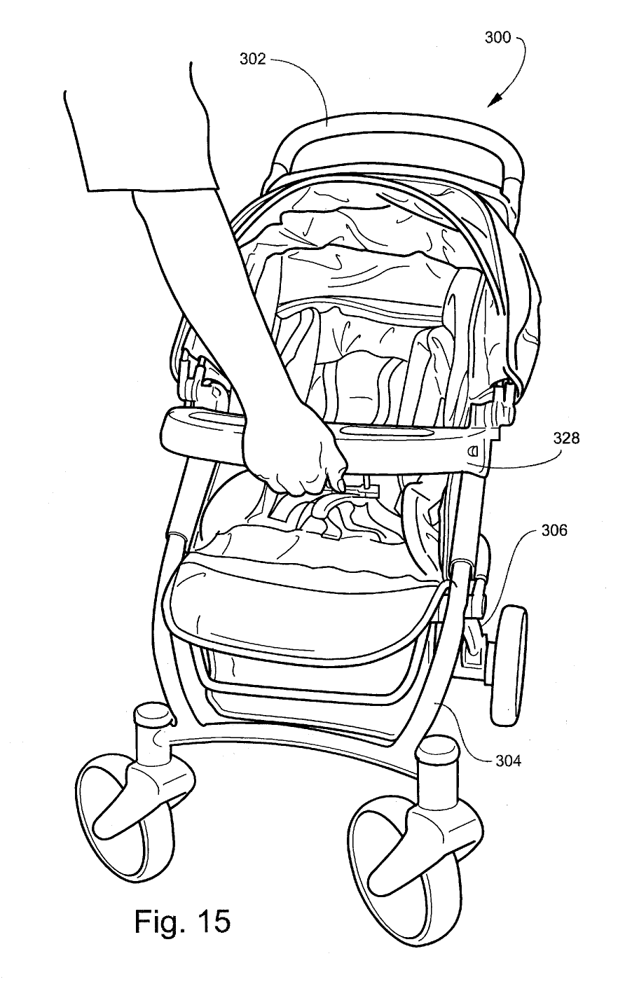

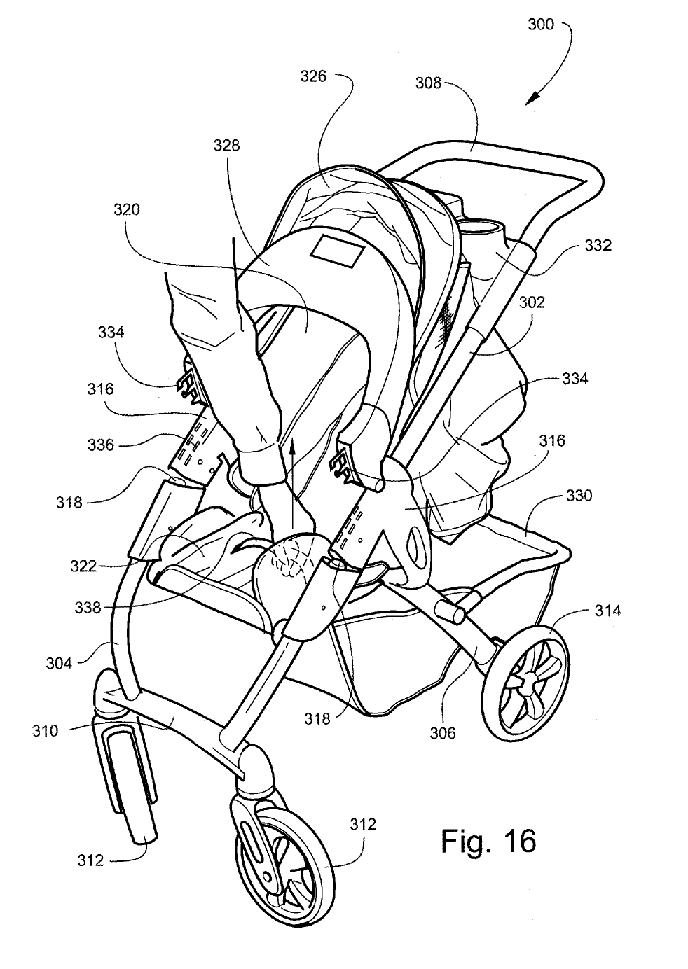

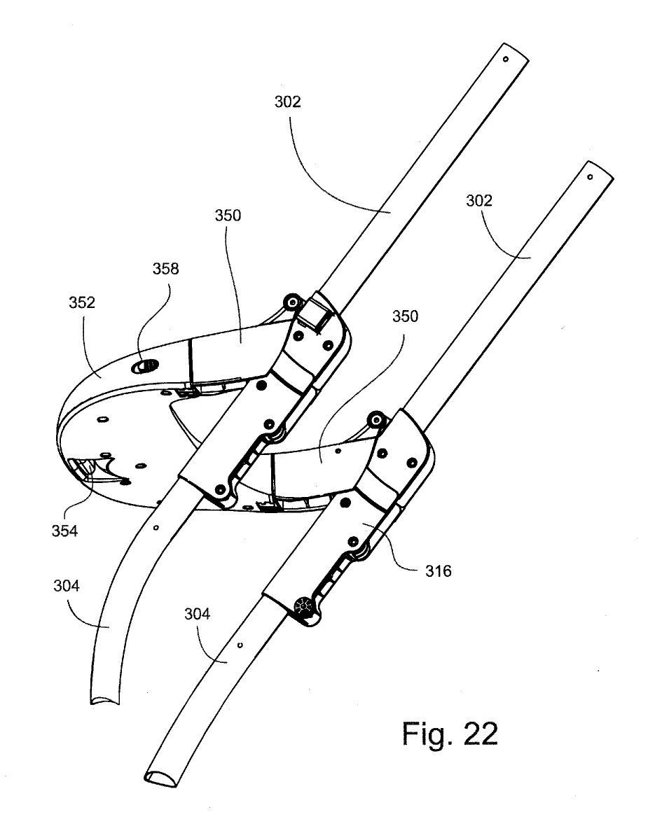

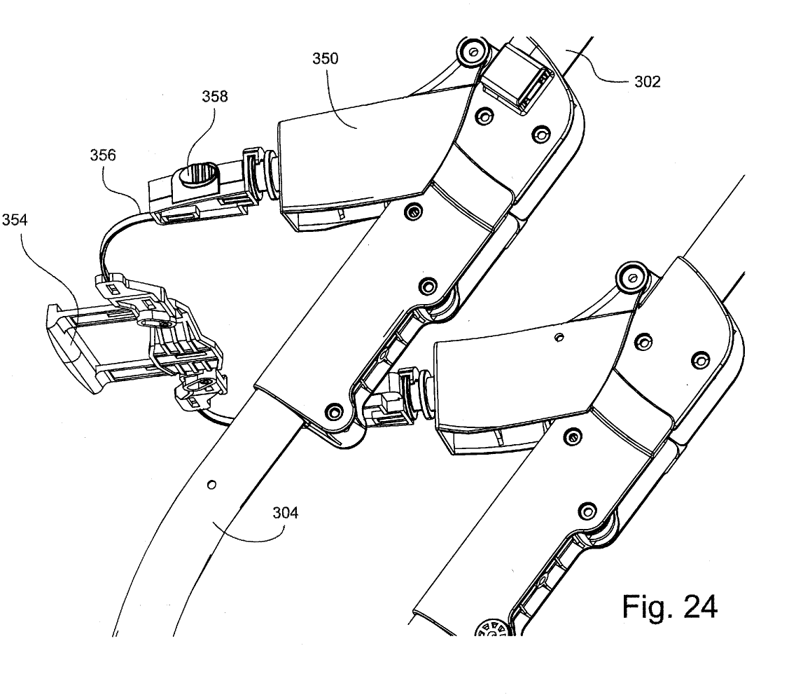

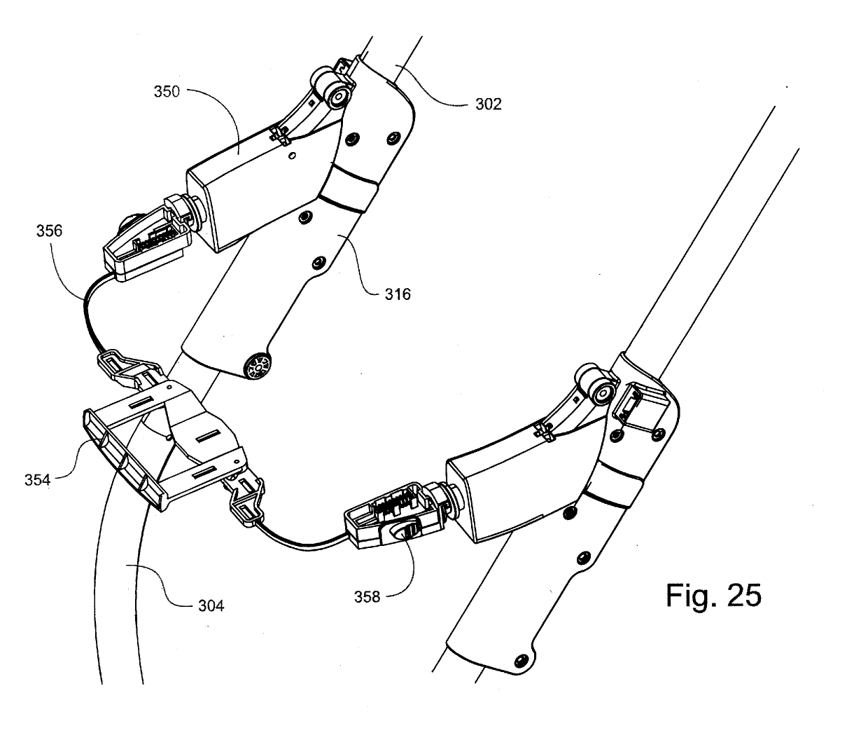

As best shown in FIGS. 15-20, collapse of the stroller 300 from the fully deployed configuration using a single hand is achieved by disengaging the frame elements 302, 304 and child tray assembly 328. Single handed collapse is advantageous in that the operator can have the other hand free to hold the child, infant carrier or other item. To first unlock the stroller, the child tray assembly 328 is pivoted to its upward position as shown in FIG. 16. The child tray assembly is unlocked/unlatched by actuating a pull mechanism 332 located in the forwardmost, bottom portion of the tray 328. The pull mechanism 332 is described in detail below referring to FIGS. 22-25. Upwardly pivoting the child tray assembly 328 disengages latch hooks 334 from engagement with catches 336 correspondingly defined through brackets 316, first frame element 302 and plungers 318. Thus, the catches 336 defined through the brackets 316, first frame element 302 and plunger 318 align such that the latch hooks 334 simultaneously pass through to engage and lock with the plungers 318, preventing the plungers 318 from translating downward with respect to the second frame element 304 when the child tray assembly 328 is in the in use position. In its deployed position, the child tray assembly 328 is latched into place just above the respective hinging points of the frame elements.

The stroller 300 is further collapsed by actuating a frame release mechanism as best show in FIGS. 14 and 18-20. In a preferred embodiment, the frame release mechanism includes a frame release element 338, such as a nylon strap, that extends laterally across the seat bottom 322 beneath the seat occupant. The frame release element 338 is routed through slots defined in the seat bottom 322 and is coupled at each of its ends to first ends of translating core cables 340, which in turn are coupled at their second ends to the plungers 318. The cables 340 are lashed to a seat bottom frame 342 and are routed within the second frame element 304 and brackets 316. The cables 340 are of the type including a stationary cable sheath 346 and translating core 348 (as best shown in FIG. 19), commonly know to those skilled in the art. The cable 340 may be secured to the seat bottom frame 342 and stroller frame elements using conventional fasteners, brackets and zip straps, indicated collectively and generally at reference numeral 344.

Actuating the frame release element 338 by pulling it upwardly causes the cable core to translate toward the frame release element 338 in the direction of the pulling force, and in turn causes a downward pulling force on the plungers 318. The plungers 318 translate downward a predetermined distance out of engagement with the second frame element 304, thus releasing the first and second frame elements 302 and 304 and allowing the to pivot toward one another. Once the first and second frame elements 302 and 304, respectively, disengage, the frame release element 338 may be released and the stroller folded. The plungers 318 are preferably spring biased in the direction toward the first frame element 302, such that the release of the frame release element 338 causes the plungers 318 to return a position protruding a predetermined distance beyond the ends of the second frame element 304 opposite the front wheels 312. The stroller 300 may be maintained in the collapsed configuration using any conventional mechanism that holds any of the frame elements together, such as a chasis lock including detents and catches that progressively catch as the stroller is collapsed. As shown in FIG. 21, the front wheels 312 and rear wheels 314 are drawn together as the frame elements fold on the hinges. During the same movement, the handle 308 is folded into a storage position near the storage basket 330 and the stroller seat 322 and canopy 326 are positioned in the space between the upper portion of the frame elements and the handle. As stated above, all of these actions are capable of being carried out with a single hand, so that one holding a child in one arm can fold or unfold the stroller as needed.

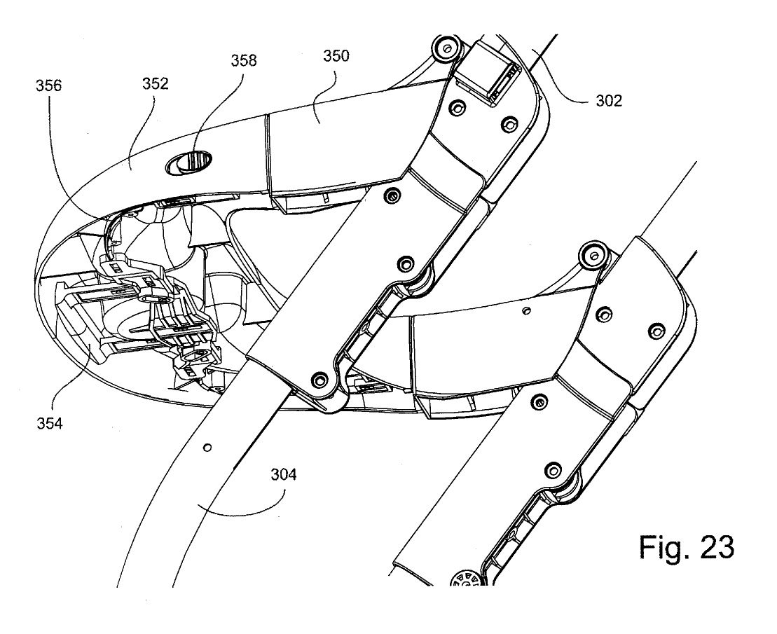

Referring to FIGS. 22-25, various stages of assembly of the child tray assembly 328 are shown to detail the construction and operation of the assembly. Referring specifically to FIG. 22, the child tray assembly 328 is shown fully assembled and pivotally attached to the first frame element 302. The child tray assembly 328 includes first and second support arms 350 that detachably engage the tray portion 352. The pull mechanism 332 located on the underside of the forwardmost portion of the tray portion 352. The child tray assembly 328 is unlatched by means of a tray release handle 354 that is pulled toward the forward edge of the tray portion, thus providing single handed operation. As best shown in FIGS. 23-25, the tray release handle 354 is mechanically coupled to the latch hooks 334 through latch hook release structure including mechanical linkage 356. As the tray release handle 354 is pulled, the linkage pulls the latch hooks 334 toward the handle 354, disengaging them from the catches defined in their respective plungers 318, thus releasing the child tray assembly 328 and allowing it to pivot upward.

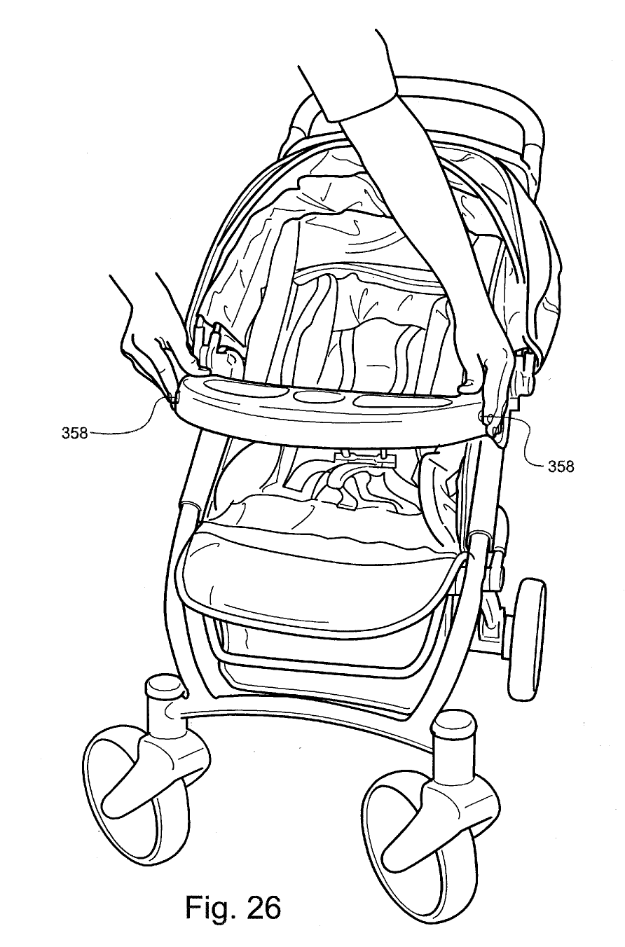

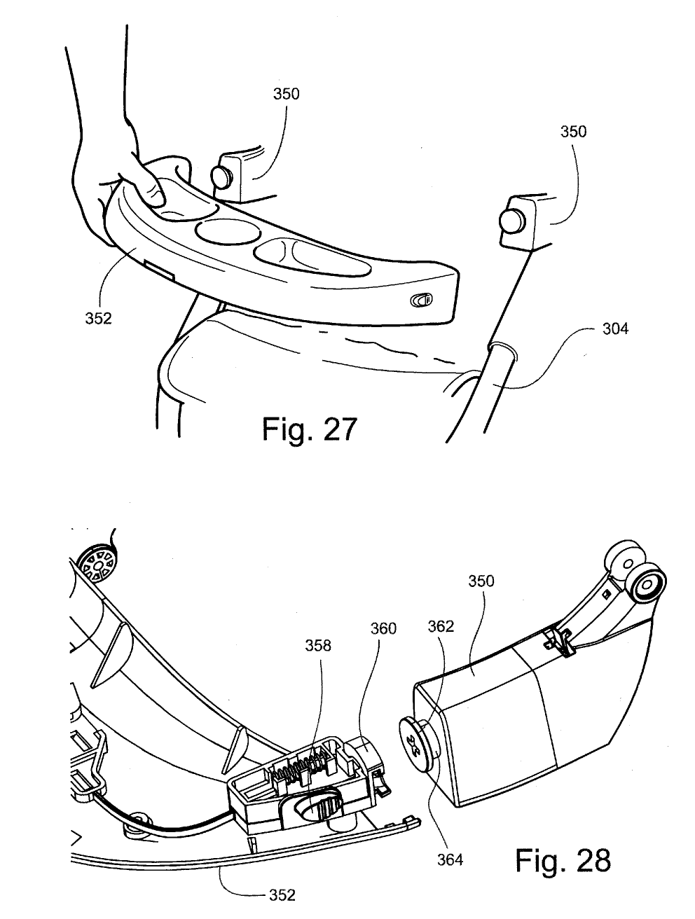

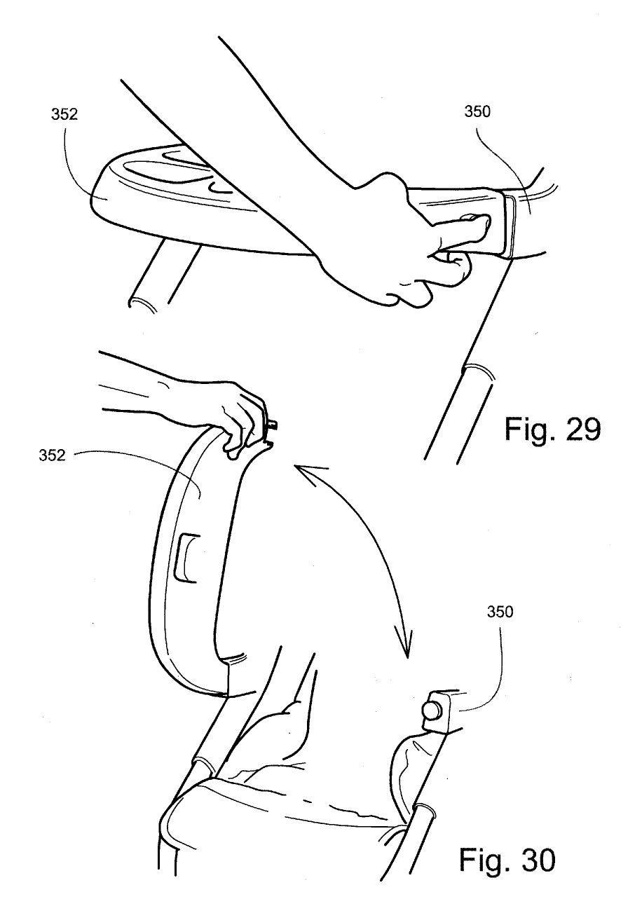

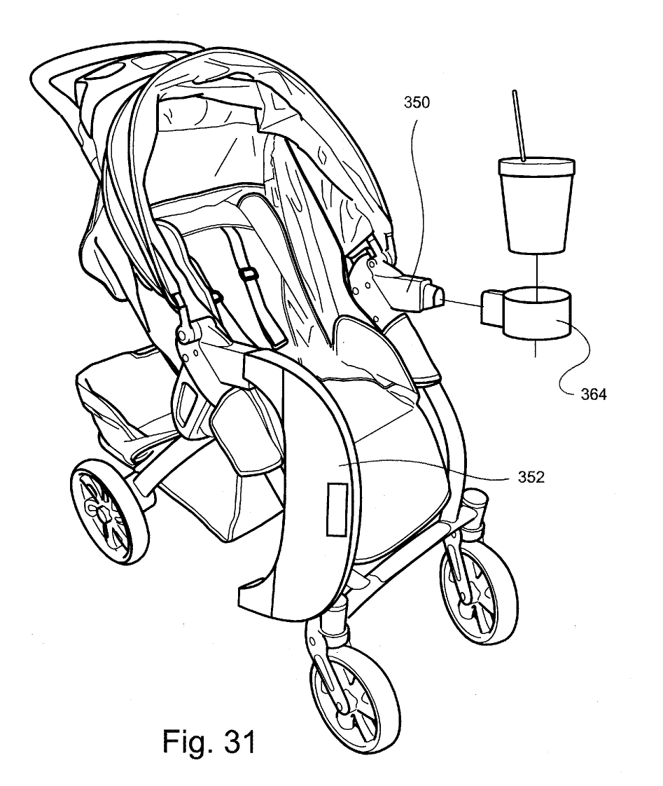

Referring to FIGS. 22-30, tray table 352 removal and pivoting with respect to the arms 350 is achieved by actuating one or both releases 358 positioned on the sides of the tray table portion 352. As best shown in FIG. 28, the tray table portion 352 defines catches 360 that engage protruding features 362 of the arms 350. The catches 360 are released when the release is pulled and the tray table portion 352 slides upwardly out of engagement with the arms 350, as shown in FIG. 27. As best shown in FIGS. 29 and 30, one side of the tray table portion 352 may be released and pivoted upwardly to one side to facilitate stroller loading and unloading. Referring to FIG. 31, one side of the tray table portion 352 may be released and rotated to one side, permitting the installation of a cupholder 364 on a tray table arm 350, thus providing a stroller accessory.

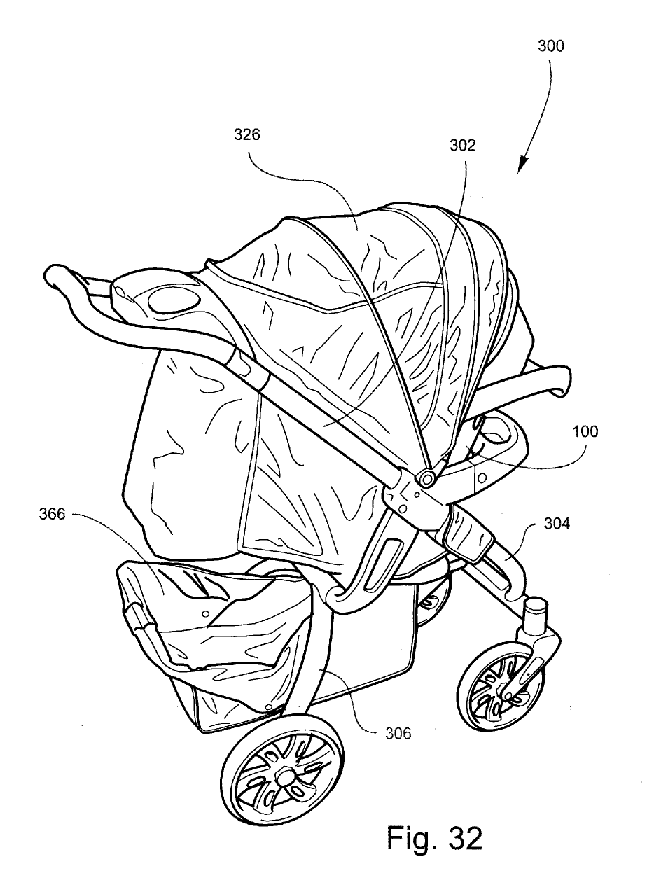

As shown in FIG. 32, the stroller 300 may optionally include a cover 366 for shielding the luggage basket 330 from the elements. The canopy 326 is also shown in the deployed configuration and fastened to the seat back 320 for shielding the seat occupant from the elements. In this position, the canopy of the infant carrier 100 can be extended rearwardly over the seat back part of the infant carrier 100, and the stroller canopy 326 can be extended forwardly over the seat bottom part of the infant carrier 100, as shown. Either canopy or both canopies are positionable as desired to partially expose or completely enclose the infant carrier occupant. With the stroller canopy 326 in its rearward, retracted position, the stroller user and the infant carrier occupant each have fall visibility with the other. The seat back 320 is shown in the reclined position hanging beneath the first frame element 302 and supported by the third frame element 306. The stroller 300 is designed to receive the infant carrier 100 in a rear facing position. Hook latches on a bottom of the infant carrier may optionally seat above and below the tray table portion 352 in the deployed position to lock the carrier in place.

While a child seating system including an infant carrier 100, corresponding seat base 200 and stroller 300 has been described with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A stroller, comprising:
a stroller frame including first, second and third frame elements that are pivotally interconnected such that the stroller is configured to fold between deployed and collapsed configurations;
seat back and seat bottom portions suspended between the stroller frame;
a frame release mechanism including a frame release element mechanically coupled to frame element releasing plungers that maintain the first and second frame elements in engagement; and
a pivoting child tray assembly that releasably engages the plungers to prevent the plungers from translating downward with respect to the first frame element when the child tray assembly is engaged with the plungers;
wherein actuating the frame release mechanism when the pivoting child tray assembly is disengaged from the plungers releases locked engagement between the first and second frame elements.

2. A stroller in accordance with claim 1, wherein the pivoting child tray assembly comprises a child tray portion releasably attached to tray support arms, and a pull mechanism for releasing engagement of the child tray assembly with the plungers.

3. A stroller in accordance with claim 2, wherein the child tray assembly includes first and second tray support arms, and wherein detachment of the child tray portion from the first arm allows the tray table portion to pivot relative to the second support arm.

4. A stroller in accordance with claim 1, wherein the tray table assembly further comprises latch hooks that engage catches defined in the plungers.

5. A stroller in accordance with claim 1, wherein the frame release element is mechanically coupled to the plungers through a translating core cable.

6. A stroller in accordance with claim 1, further including a seat bottom frame, and wherein the translating core cable is maintained on the seat bottom frame.

7. A stroller in accordance with claim 1, wherein the frame release element is positioned about the seat bottom.

8. A stroller in accordance with claim 1, wherein the plungers are biased in the direction of the first frame element.

9. A stroller in accordance with claim 1, further comprising at least one wheel mounted to the second frame element and rear wheels mounted to the third frame element.

10. A stroller in accordance with claim 1, wherein the child tray assembly pivots upwardly with respect to the first frame element to disengage the child tray assembly from the plungers, and wherein the third frame element is trapped between the first and second frame elements when the stroller is in the collapsed configuration.

11. A stroller, comprising:
a stroller frame have pivotally connected first, second and third frame elements configured to fold the stroller between deployed and collapsed configurations;
seat back and bottom portions suspended between the stroller frame;
a frame release mechanism for releasing engagement between the first and second frame elements to collapse the stroller; and
a pivoting child tray assembly for releasably locking engagement of the first and second frame elements together.

12. A child seating system, comprising:
(a) an infant carrier comprising a molded shell defining seat back and seat bottom portions, a carry handle pivotally attached to the shell, and a height adjustable winged headrest;
(b) a vehicle seat base for receiving the infant carrier and securing the infant carrier to a vehicle seat; and
(c) a stroller for receiving the infant carrier, the stroller comprising:
a stroller frame including first, second and third frame elements that are pivotally interconnected such that the stroller is configured to fold between deployed and collapsed configurations;
seat back and seat bottom portions suspended between the stroller frame;
a frame release mechanism including a frame release element mechanically coupled to frame element releasing plungers that maintain the first and second frame elements in engagement; and
a pivoting child tray assembly that releasably engages the plungers to prevent the plungers from translating downward with respect to the first frame element when the child tray assembly is engaged with the plungers;
wherein actuating the frame release mechanism when the pivoting child tray assembly is disengaged from the plungers releases locked engagement between the first and second frame elements.

13. A child seating system in accordance with claim 12, wherein the height adjustable winged headrest includes a slide that incrementally slides along tracks carried on a rear surface of the shell for adjusting the height of the winged headrest.

14. A child seating system in accordance with claim 12, wherein the vehicle seat base further comprises an anti-rebound bar that projects outwardly and upwardly with respect to a foot end of the seat base.

15. A child seating system in accordance with claim 12, wherein the vehicle seat base further comprises a pair of spaced-apart belt hooks and a belt lock-off positioned therebetween mounted on a top surface of a seat base housing positioned on a foot end of the seat base for securing a vehicle seat belt to the seat base.

16. A child seating system in accordance with claim 12, wherein the pivoting child tray assembly comprises a child tray portion releasably attached to tray support arms, and a pull mechanism for releasing engagement of the child tray assembly with the plungers.

17. A child seating system in accordance with claim 12, wherein the child tray assembly includes first and second tray support arms, and wherein detachment of the child tray portion from the first arm allows the tray table portion to pivot relative to the second support arm.

18. A child seating system in accordance with claim 12, wherein the tray table assembly further comprises latch hooks that engage catches defined in the plungers.

19. A child seating system in accordance with claim 12, wherein the plungers are biased in the direction of the first frame element.

20. A child seating system in accordance with claim 12, wherein the child tray assembly pivots upwardly with respect to the first frame element to disengage the child tray assembly from the plungers, and wherein the third frame element is trapped between the first and second frame elements when the stroller is in the collapsed configuration.
